(19) United States
(12) Patent Application Publication
(10) Pub. No.: US 2020/0372092 A1
(43) Pub. Date: Nov. 26, 2020

(54) SYSTEM AND METHOD TO PROMOTE CONTENT VIRTUALLY

(71) Applicant: DIEGO ARMANDO MERCADO SANCHEZ, BOGOTA (CO)

(72) Inventor: DIEGO ARMANDO MERCADO SANCHEZ, BOGOTA (CO)

(21) Appl. No.: 16/881,077

(22) Filed: May 22, 2020

Related U.S. Application Data
(60) Provisional application No. 62/851,749, filed on May 23, 2019.

(51) Int. Cl. G06F 16/957; G06F 16/958; G06Q 30/02

(52) U.S. Cl. CPC G06F 16/9574; G06Q 30/0201; G06Q 30/0273; G06F 16/972

(57) ABSTRACT

A computer implemented virtual platform for cross platform content or media promotion of content owner and direct payment to the content owner to show support to the content and the content owner. The virtual platform of present invention is coupled with the multiple other platforms or channels such as social networking platforms, websites, user interfaces or other programmed system as a backend mechanism and allows the content owner to permit the virtual platform to create a boost button close to the content that facilitates any other person or entity to promote the content of the content owner on any of the aforesaid channels. The computer implemented system of present invention have two stages of agreement, first the agreement by the content owner of what ratio of the user's total budget they wish to retain as a fee for their content, second the agreement by the user of which channels they will use to promote the content on, what market segmentation they wish to use and what total budget they wish to set.

### CROSS-REFERENCE TO RELATED APPLICATION

This application claims the benefit of U.S. Provisional Application No. 62/851,749, filed May 23, 2019, entitled “System or Method to promote content virtually”.

### FIELD OF THE INVENTION

The present invention relates to the system and method of cross platform media content delivery and democratization of content generation and promotion across all virtual platforms. More particularly, it is a system that allows any third party to boost and promote the media content of any content holder against a direct payment of fee to the content holder.

### BACKGROUND OF THE INVENTION

Thanks to the invention of the internet, we have been witness to how the media business has changed its content from massive communication media delivered through television channels, radio stations, newspapers and magazines to the content delivered by influencers and social networks enabling anyone to create, share and promote (paid or otherwise) media content and information. As a result, traditional media content delivery systems have been losing market share. During the last century the media content delivery business was simple; these massive communication media companies charged other entities to advertise via their channels, and in the case of print media, they used to sell their content physically on paper, in both cases generating income.

In past models of the media sector, there existed economic barriers to promoting and creating media content. With the arrival of the internet and later social media, a huge portion of content started to be made online and passed through the internet. We have seen many traditional media businesses shutting down because they haven't found new ways of generating income in this new system where customers want to access all the content online and for free.

With the rise of the internet and social networks, the number of creators of content has increased exponentially from a few media creators to millions of entities or persons who create content online. The way creators of content work has changed and has become far more simple, the interface may have changed as well and become far more accessible and user friendly but the substance of the content remains the same. The business model may have opened and become more accessible but it is still the same model. From the big media companies to an influencer who has 10,000 followers the way of generating income across the sector is as follows:
Charging a fee in money or in kind to advertise on a media channel, whether it is traditional, through a large online company or through an individual's social network profile. Advertising through these channels can be limited by its need to conform or at the least not contradict the ownership of the channel's attitudes, values and existing commercial agreements. For example a news outlet may have a political position, a influencer may have prior agreements with companies that are controversial and a social network may have limitations on the way it can promote or address certain social issues.
Selling the content to the customers by subscription or batch purchase and limited content purchases. This model has the limitation or drawback that the customer has ready access to large amounts of similar content for free. This causes resentment and friction between users/customers and the content producers.
Selling content to media channels or any other user interface. The internet may have made creating and publishing content easier but the road to monetizing content remains economically exclusive. Content can be made more cheaply but television programming schedules, streaming giants like Netflix or You Tube remain difficult to access, not solely because of closed networks within the circles of programming decision makers, but also because of sheer quantity and saturation of content. The process of promoting content to try and break through these barriers is, as previously referred to, expensive with bloggers, social influencers and internet companies charging a premium.
Asking for donations from users or other entities via donations. An example of this revenue model is Wikipedia, where the creators or the owners of the user interface ask for periodic donations from users. Although a solid and time proven model the integration of a donation based system rarely has a cross platform/interface application.
Generating user influxes via high quality or popular content and receiving financial rewards in exchange. The most common example of this is the relationship of You Tube with its content creators (You Tuber's). The drawback of the current system is that it is often restricted to the platforms or interfaces owned by a particular entity.
Lastly it is important to note that none of the above are mutually exclusive, many or even most of the content creators look for income through a mix of all these methods and many are constantly migrating from one to another.

Although the monopoly of traditional media is over, influencers, internet companies and other online players have stepped in and the user feels that not much has really changed, the content they receive is chosen for them. The social networks still allow the user a degree of autonomy that they did not enjoy previously as they allow users to share content with their network.

As previously mentioned, the social networks give the user autonomy to create and share content, users can only publish content and only certain user account types can boost their own content. This means that there is no option to boost content from third parties. The social networks have made the spread of content more democratic but have failed to surpass the basic premise of traditional media, in the sense that it is still special interest groups promoting and spreading their own interests. For example a political profile will engage in boosting its political messages and a co-operate account will engage in boosting content for its products and services.

Therefore, there exists a dire need of a virtual platform that may allow any individual or entity to promote or boost content of any third party over a cross platform on internet. Further there exists a need of a virtual platform that may allow the user to boost the message of importance for them without having to create a special interest profile. Moreover, there exists a need of platform that may allow boosting of a content holder from which the content holder also earn some fee.

### SUMMARY

This summary is provided to introduce a selection of concepts in a simplified form that are further disclosed in the detailed description of the invention. This summary is not intended to identify key or essential inventive concepts of the claimed subject matter, nor is it intended for determining the scope of the claimed subject matter.

A computer implemented system for cross platform promotion/boosting of media content and method of working of said system is provided. The computer implemented system or a virtual platform of present invention allows any person or entity to boost online the media content of a consenting third party such as a media or content creator, media or content owner, etc. to a segment of the population, channels of communication and user interfaces previously chosen by said person. The person who is a creator of the content or media, or the owner of the content or media, or the user interfaces where the user uploads the content or media such as a social networking platforms, websites or any other application will now be referred to as the “Content Holders” and the person or entity promoting or boosting the content or media of the content holder will be referred to as the “Booster”.

According to one embodiment, the computer implemented system of present invention is a virtual platform linked with all the channels such as social networking platforms, websites and application interface to allow the boosters to promote the media or content of the content owner on any said cross platforms or channels. The virtual platform of present invention first allows the content holder to permit boosters to boost their media or content via the virtual platform. Once the content holder permits for the boost option, the virtual platform creates a boost button around the post or content on user interface where the content owner uploads the media or content. This virtual platform created booster functionality or boost button of present invention facilitates the boosters to select, upload and then promote the content of the content holder they deem relevant.

The virtual platform and the computer implemented system of present invention a system of a paid promotion to allow the boosters to reach market segments they feel are relevant to the content while simultaneously allowing the content owner to set a fee ratio within the boosters budget to financially recompense them for the use of content. Hence, the computer implemented virtual platform of present invention have two stages of agreement. First, the agreement by the content holder about the ratio of the booster's total budget the content holder wishes to retain as a fee for their content. Second, the agreement by the boosters for the channels on which they will promote the content, the market segment they wish to use and the budget they wish to set for the promotion or boosting of the content.

### BRIEF DESCRIPTION OF DRAWINGS

The foregoing summary, as well as the following detailed description of the invention, is better understood when read in conjunction with the appended drawings. For the purpose of illustrating the invention, exemplary constructions of the invention are shown in the drawings.

However, the invention is not limited to the specific methods and structures disclosed herein. The description of a method step or a structure referenced by a numeral in a drawing is applicable to the description of that method step or structure shown by that same numeral in any subsequent drawing herein.

FIG. 1 shows a block diagram of the present computer implemented system and the virtual platform.

FIG. 2 shows a work and payment flow diagram of the computer implemented system and the virtual platform of present invention.

FIG. 3 exemplarily illustrates booster button of the present computer implemented system close to the user interface of the individual or any entity on a social networking platform (i.e. Facebook®).

FIG. 4A and FIG. 4B exemplarily illustrates a booster button of the present computer implemented system in an online newspaper's homepage and close to the online newspaper's separate article respectively.

FIG. 5 exemplarily illustrates a booster button of the present computer implemented system in a video streaming website.

### DETAILED DESCRIPTION OF INVENTION

The embodiment herein and the various features and advantageous details thereof are explained more fully with reference to the non-limiting embodiments and detailed in the following description. Descriptions of well-known components and processing techniques are omitted so as to not unnecessarily obscure the embodiments herein. The examples used herein are intended merely to facilitate an understanding of ways in which the method and embodiments herein may be practiced and to further enable those of skill in the art to practice the embodiments herein. Accordingly, the examples should not be construed as limiting the scope of the embodiments herein.

The use of terms “including”, “comprising”, or “having” and variations thereof herein are meant to encompass the items listed thereafter and equivalents thereof as well as additional items. Further, the terms, “an” and “a” herein do not denote limitation of quantity, but rather denote the presence of at least one of the referenced items.

As used herein, the term “content holder” refers to all the creators or designers of the content such as musicians, writers, video makers, journalists, documentary makers, bloggers, influencers, brands, companies etc that either creates the content or owns the content.

As used herein, the term “channel of promotion” refers to the online newspapers, online magazines or publication websites, television companies or channels, websites, Apps, social networking platforms, online streaming companies or any other user interface that shows and transmits the content online.

And as used herein, the term “Boosters” refers to any individual or entity that promotes the content of the content holder on any cross platforms or channels.

A computer implemented system and a virtual platform of present invention is a platform that is coupled with the multiple other platforms or channels such as social networking platforms, websites, user interfaces or other programmed system as a backend mechanism where the content holder uploads the content and the boosters promotes the content of the content holder on same or other such platforms or channels. According to one embodiment, when the content holder uploads the content on user interface of any of the promotion channel or platform, the computer implemented virtual platform of present invention asks for permission from the content holder if the content holder wishes any booster to promote his content. Once the content owner provides an express permission to the virtual platform of present invention for promotion of the content, it automatically creates a link or a booster button attached to or close to the content that allows any third party (boosters) to do a paid promotion of the content on the same platform/channel where the content holder first uploaded the content or any other cross platforms coupled with the computer implemented virtual platform of present invention by an API (application programming interface).

The channel of promotion can be both a content holders and channels of promotions simultaneously. For example, the newspaper that has already given an access to an API-booster button, posting an article about a way of saving an elephant from extinction. A reader gets interested in the article, they become a booster, the booster decides to assign a budget of the $10 USD to promote it on the internet, also, the same newspaper has agreed with this virtual platform of present invention to be one of the promotional channels for boosters. In the options menu, the booster can decide to assign a budget, so they decide to assign 30% to promote it on Facebook®, 20% on Google®, 45% in the same newspaper who is the content holder, and 5% for fee to the holder of the content and the virtual platform of present invention.

According to one embodiment, the computer implemented virtual platform of present invention facilitates mandatory screening process for all the content holder giving permission or consent for boosting to prevent unethical or illegal content. The computer implemented virtual platform further allows the content holder opt for a booster button upfront and the method or process of opting for a booster button for the content includes steps of: allowing the content holder to sign in within the virtual platform; allowing the content holder to ask for a permission to attach the booster button to their content; the content holder will then be allowed to connect to this virtual platform through an API connection allowing their content to be boosted by the boosters; then the API connection of the virtual platform asks for the URL of the content and/or asks to upload the content over the virtual platform and/or asks for more detailed specification such as sizes, pixels, number of words, format, specific programming language etc. to allow a good API connection; and allowing the content holder to decide the fee they wish to charge from the boosters for allowing them to boost the content. The content holder may charge a fixed fee per transaction and/or a % fee and/or a donation and/or no payment at all.

The computer implemented virtual platform and system of present invention further facilitates the content holder to define the rights they wish to give to the boosters via the booster button like the restriction on the market segments the boosters can engage, the budget limit, the dates, time and context in which the content needs to be boosted which is in order to prevent boosters to boost the content which is not relevant where promoted. One example of this is a local blogger having the content pertaining to a local issue promoted in another area which is useless hence the restriction allows content holder to prevent unnecessary and useless promotion of the content.

According to one embodiment, when the content holder opt in for the booster button and promotion with the present virtual platform, the platform creates a booster button close to the content of the content holder as explained. The created booster button allows content holder to decide minimum required budget for paid promotion or boosting, percentage of money as a fee from the total budget, a fixed amount independent of the amount the budget which the boosters wants to use to sponsor the content, a voluntary donation from the booster or allowing the boosters to boost the content for free.

According to one embodiment, the computer implemented system and virtual platform also facilitates the any person or entity (boosters) who wishes to promote the content of any third party (content holder) to assign a budget in accordance with the budget limit given by the content holder during connection of the content with the API of the present computer implemented system. To assign a budget by the booster, the booster button of the virtual platform close to the content of the content holder leads the boosters to an interface of the computer implemented virtual platform that further facilitates the boosters to select desired boosting parameters such as; the amount of money the booster wants to spend for the content to be boosted; available or desired channels or platforms of promotion where the booster wishes to promote the content of the content holder; the time and date the booster wants the content to be boosted; the segment of the population and the location that the booster want to target; selection of method of payment to the content holder based on the options selected by the content holder during the time of connection of the content with the API of the computer implemented system; and to choose the form of payment that may be through credit cards, debit cards, money transfers, deposits or checks.

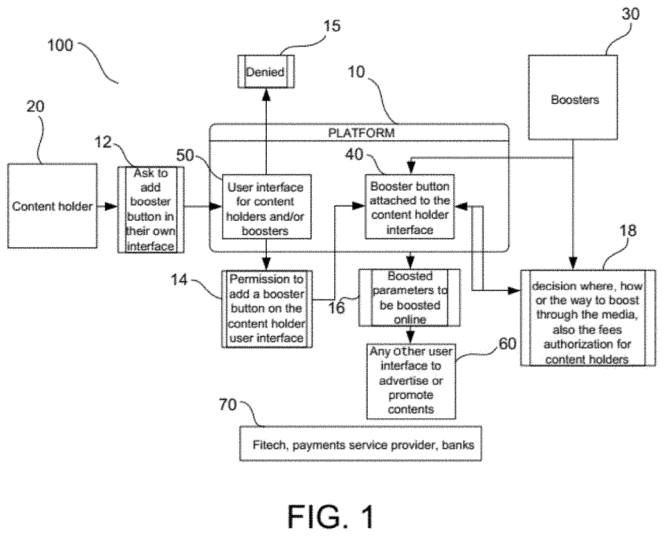

FIG. 1 shows a block diagram of the present computer implemented system 100 and the virtual platform. According to present embodiment, the virtual platform 10 of the present system 100 is coupled as backend mechanism with all the promotion channels and other platforms having user interfaces of individuals or entities such as social networks, websites, apps, newspapers, streaming sites etc. where the content holder 20 uploads their content and where the boosters 30 may do a paid promotion of the content of the content holder 20 on same platform/channel or any other cross platform. According to the present embodiment, the content holder 20 who wishes to boost their content may access the virtual platform 10 as per the process explained above and may ask the virtual platform to add booster button on their own interfaces 12 near the content. The virtual platform includes a user interfaces 50 for content holders and or boosters that allows content holders and boosters to select parameters and conditions for boosting.

According to one embodiment, the virtual platform check conditions of promotions of content holder and boosters over a user interface for content holders and/or boosters and either denies 15 for the permission for boosting using the virtual platform 10 or accepts and gives permission to the content holder to add a booster button on the content holder user interface 14 that in turns causes the virtual platform 10 of the computer implemented system 100 to attach a booster button 40 to the content holder interface.

The boosters 30 are allowed by selecting the attached booster button to the content of the content holder 40 to boost the content over the same channel of promotion or any other cross channels or platforms. According to one embodiment, the boosters 30 are further allowed, before promoting, to take decision 18 regarding where, how or the way to boost through media and also the fee authorization for content holder 20. According to the boosters 30 decisions, the platform creates a booster parameters to be boosted online 16 and promotes or boosts the content over the cross platforms and user interfaces 60. The computer implemented system of present invention further facilitates methods and system for direct payment 70 to the content holder 20.

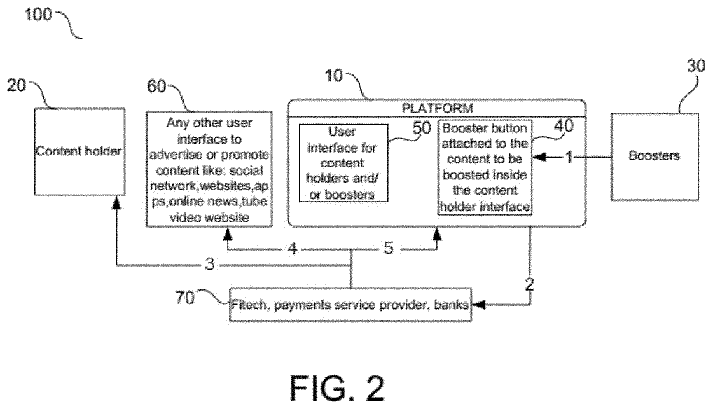

FIG. 2 shows a work and payment flow diagram of the computer implemented system 100 and the virtual platform 10 of present invention. The stepwise flow of present embodiment discloses that the platform 10, after granting permission to the content holder, attaches the booster button 40 close to the content of the content holder 20. The booster button 40 is a part of the virtual platform 10 that allows the booster to boost contents of the content holder on any cross platform user interfaces.

According to one embodiment, the virtual platform 10 of present invention receives budgeted payment for promotion from the boosters 30 and transfers that money to the content holder (step-3), to the user interfaces of channels where the content is going to be promoted (step-4) and charges a fee for the service being given by the virtual platform itself (step-5) using a payment service providers 70.

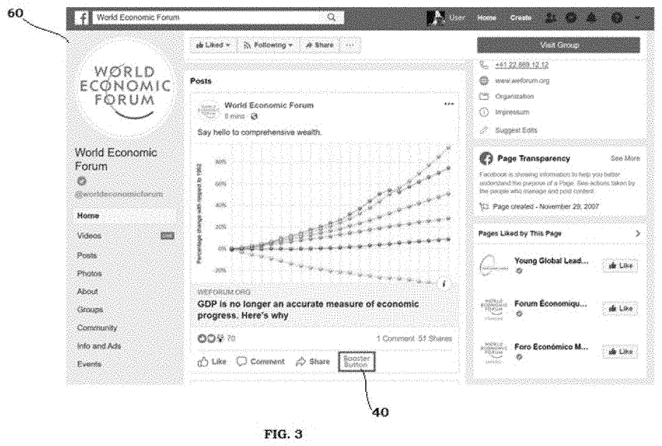

FIG. 3 exemplarily illustrates booster button 40 of the present computer implemented system 100 close to the user interface of the individual or any entity on a social networking platform 60 (i.e. Facebook®). Thus, this booster button 40 which is a part of a computer implemented system 100 and virtual platform 10 will allow anyone interested to boost the post or content by pressing the booster button 40 that takes the booster to the user interface over the virtual platform 10 for deciding further parameters.

The booster button 40 is different to share option available of the networking platform as it allows the booster to assign a budget to boost the content of a third party content holder and also allows assigning a fee to the content holders.

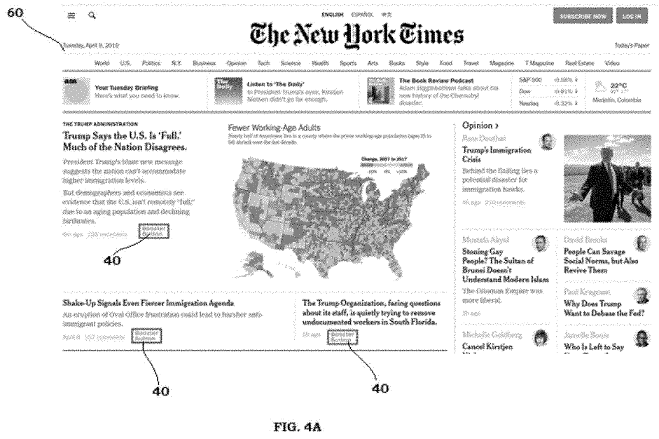

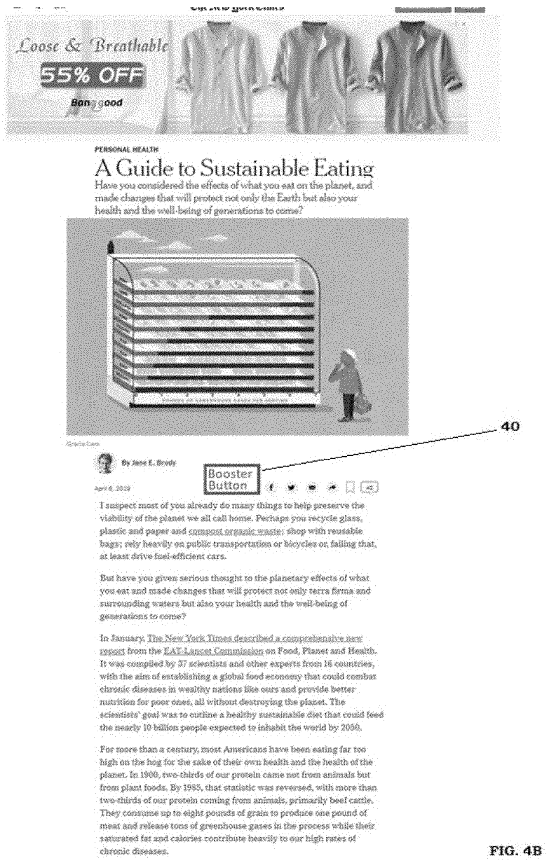

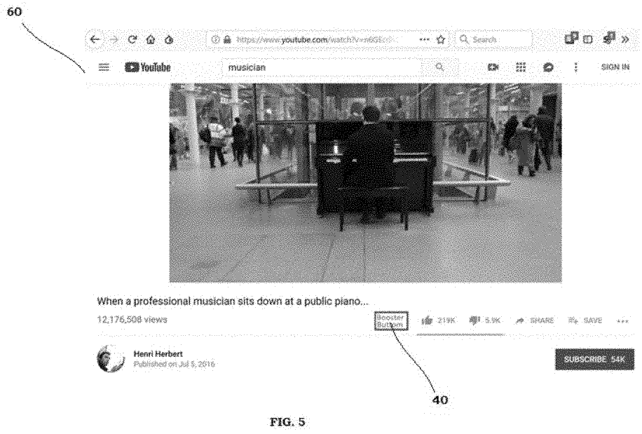

FIG. 4A and FIG. 4B exemplarily illustrates a booster button 40 of the present computer implemented system in an online newspaper's homepage and close to the online newspaper's separate article respectively. While, FIG. 5 exemplarily illustrates a booster button of the present computer implemented system in a video streaming website. The difference between already available share option of these platforms and the booster button 40 of our virtual platform is that the booster button allows any person or entity to pay to boost the content on internet and also giving an option of giving a fee to the holder of the content.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

1. A computer implemented method for a cross platform promotion or a boosting of a media content using a computer implemented virtual platform is comprising steps of:
allowing a content holder of the media content to ask for a permission from the computer implemented virtual platform to attach a booster button on the media content of the content holder; and
allowing any of a individual or an entity (a boosters) to promote the media content of the content holder on any of a channel of promotion via the computer implemented virtual platform by selecting the booster button on the media content.

2. The computer implemented method of claim 1, wherein the step of ask for the permission for the booster button from the computer implemented virtual platform further comprising steps of:
allowing the content holder to sign in within the computer implemented virtual platform;
connecting the media content with the API of the computer implemented virtual platform by the computer implemented virtual platform;
allowing the content holder to decide a fee to be charged from the boosters for boosting the media content; and
allowing the content holder to limit to the a segment of a population, a time of a day, a date and a location the media content may be sponsored by the boosters.

3. The computer implemented method of claim 1, wherein the step of promoting the media content by the boosters by selecting the booster button is further comprising steps of:
selecting by the booster the amount to pay for the content to be boosted;
selecting the channel of promotion;
selecting time, date and segment of population to be targeted; and
choosing a form of payment for the fee decided by the content holder.

4. The computer implemented method of claim 1, wherein the computer implemented virtual platform is coupled with all the channels of promotions such as online newspapers, online magazines or publication websites, television companies or channels, websites, Apps, social networking platforms, online streaming companies or any other user interface that shows and transmits the content online.

5. The computer implemented method of claim 1, wherein the fee is any of a fixed fee per transaction or a % fee or a donation or no fee at all.

6. The computer implemented method of claim 1, wherein the computer implemented virtual platform receives a budgeted payment for promotion from the boosters and transfers to the content holder, to a user interface of the channel of promotion and charges some fee for a service of the computer implemented virtual platform itself.

7. The computer implemented method of claim 1, wherein the content holder is any of a musicians, a writers, a video makers, a journalists, a documentary makers, a bloggers, influencers, a brands, a companies that either creates the content or owns the content.
